(19) United States
(12) Patent Application Publication
(10) Pub. No.: US 2010/0252269 A1
(43) Pub. Date: Oct. 7, 2010

(54) SYSTEM AND METHOD FOR MONITORING SUBSEA WELLS

(75) Inventor: Philippe Legrand, The Woodlands, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/750,933

(22) Filed: Mar. 31, 2010

Related U.S. Application Data
(60) Provisional application No. 61/165,817, filed on Apr. 1, 2009.

(51) Int. Cl. E21B 47/00; E21B 47/12; E21B 43/01; G01V 3/00

(52) U.S. Cl. 166/336; 166/338; 340/853.2

(57) ABSTRACT

A system for subsea wellbore monitoring is disclosed. The system includes: a communication control unit configured to be disposed at a sea floor and connected to a monitoring unit that is disposable in communication with the wellbore; a plurality of control unit connection ports disposed on the control unit and configured to operably connect with the subsea wellbore, the plurality of control unit connection ports including at least one blank control unit connection port; and a switch disposed in the control unit including a plurality of switch connection points, the plurality of switch connection points including at least one blank switch connection point configured to be operably connected to the at least one blank control unit connection port. A method of modifying a subsea wellbore monitoring system is also disclosed.

### BACKGROUND

In hydrocarbon exploration operations, subsea well boreholes are drilled by rotating a drill bit attached to a drillstring, and may be bored vertically or bored in selected directions via geosteering operations. Various devices are utilized and submerged at or proximate to the wells for controlling and monitoring production and/or various properties of the wells.

Such devices include communication/monitoring devices used to communicate between wellbores and units located, for example, at the sea floor. These communication/monitoring devices may include multiplexers to allow sea floor units to communicate with a number of wellbores and with surface locations. The communication/monitoring devices are configured to include multiple connection ports that are individually wired to communicate with specific wellbores. Configuring such connection ports can incur significant costs to ensure that sea floor units have sufficient connection ports to be able to interface with multiple desired wellbores.

### BRIEF DESCRIPTION OF THE INVENTION

A system for subsea wellbore monitoring includes: a communication control unit configured to be disposed at a sea floor and connected to a monitoring unit that is disposable in communication with the wellbore; a plurality of control unit connection ports disposed on the control unit and configured to operably connect with the subsea wellbore, the plurality of control unit connection ports including at least one blank control unit connection port; and a switch disposed in the control unit including a plurality of switch connection points, the plurality of switch connection points including at least one blank switch connection point configured to be operably connected to the at least one blank control unit connection port.

A method of modifying a subsea wellbore monitoring system includes: retrieiving the wellbore monitoring system from a subsea location, the system including a control unit connected to a monitoring unit disposable in communication with a first wellbore, the control unit including a switch disposed therein for control of monitoring components in the monitoring unit and a plurality of control unit connection ports having at least one blank control unit connection port, the switch including a plurality of switch connection points including at least one blank switch connection point; and upgrading the control unit to populate the at least one blank switch connection point to the at least one blank control unit connection port, and configuring the at least one blank control unit connection port to be operably connected to a an additional wellbore selected for monitoring.

### BRIEF DESCRIPTION OF THE DRAWINGS

The following descriptions should not be considered limiting in any way. With reference to the accompanying drawings, like elements are numbered alike:

FIG. 1 depicts a top view of an embodiment of a subsea well monitoring system;

FIG. 2 depicts a side view of the subsea well monitoring system of FIG. 1;

FIGS. 3A-3D depict an embodiment of a monitoring unit of the system of FIG. 1; and

FIG. 4 is a flow chart providing an exemplary method of monitoring components in a wellbore and/or upgrading the system of FIG. 1.

### DETAILED DESCRIPTION OF THE INVENTION

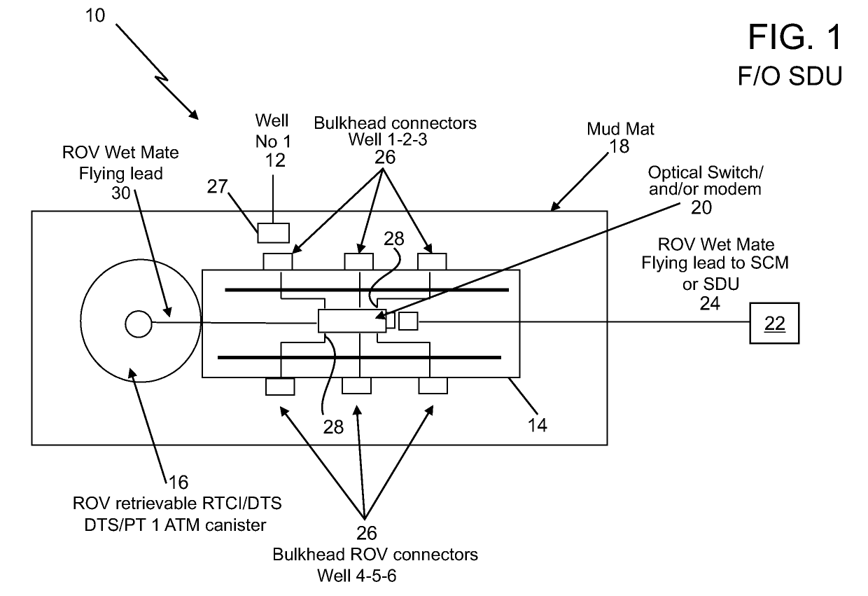

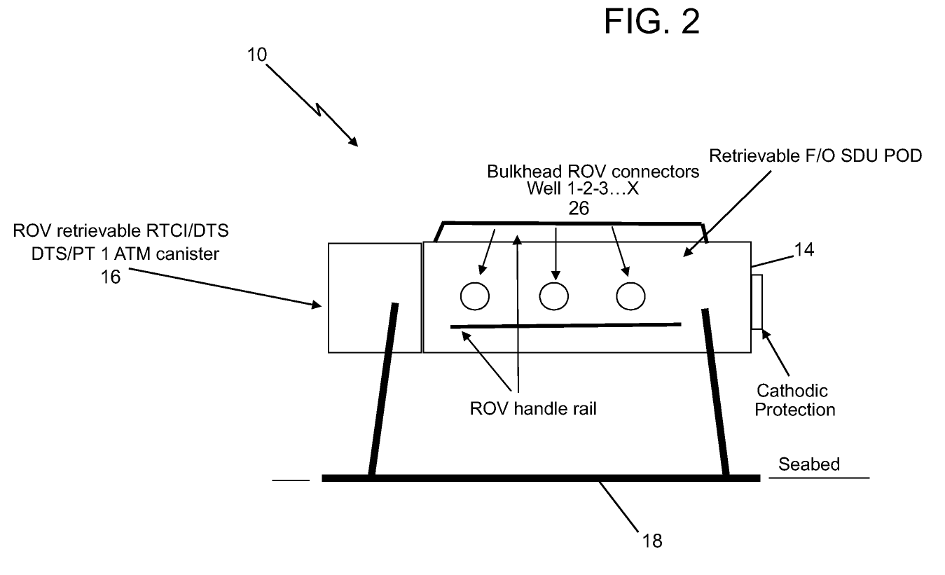

Referring to FIGS. 1 and 2, an exemplary embodiment of a subsea well communication and/or monitoring system 10 includes one or more components configured to be disposed at or near a subsea surface in proximity to a wellbore 12 for monitoring the wellbore 12, components (such as sensors) located in the wellbore 12, and/or a surrounding underground formation. Each wellbore is connected to a wellhead that may include a tree having a communication path to pass signals to sensors and other components deployed in the wellbore 12. For example, the system 10 is configured to be disposed on a pad in proximity of the wellbore 12 to be monitored and/or in proximity to an associated tie-back. In one embodiment, proximity is defined as within reach of a well jumper associated with the wellbore 12. The system 10 includes a subsea control unit or box 14 connected to a monitoring unit 16 that is configured to be connected to the wellbore 12. The box 14 is a subsea enclosure (also referred to as a “pod” or “POD”), such as a “dumb iron” pod, that supports the monitoring unit 16 and switching/control modules.

The control unit or POD 14 includes a communication/control module or control/distribution box 28 that is configured to be operably connected to one or more wellbores, and is upgradeable to allow a user to configure additional connections to accommodate additional selected wellbores. The control/distribution box 28 is operably connected to the monitoring unit 16 for control of various interrogators and other components in the monitoring unit 16.

In one embodiment, the control/distribution box 28 and monitoring unit 16 are mounted on a subsea platform 18 such as a mud mat. The control/distribution box 28 and monitoring unit 16 may be detachable from the POD 14 and/or retrievable by, for example, a remote-operated vehicle (ROV). The control/distribution box 28 may include transmission equipment to communicate with remote PODs and/or surface facilities. Such transmission equipment may take any desired form, and different transmission media and connections may be used. Examples of connections include electrically wired connections, tubing control lines, fiber optic connections, and wireless connections such as an acoustic modem.

In one embodiment, the system 10 includes components configured to receive measurement signals from the monitoring unit 16 and communicate with a surface facility over a communications connection. For example, the communications connection is facilitated by a subsea power or signal jumper and/or an “umbilical”, which extends from the system 10 to the surface facility. The system 10 may also be configured to receive control signals from the surface facility to control operation of components in the system 10 and/or the wellbore 12.

The control/distribution box 28 includes any of various components capable of performing functions such as communication, switching, data processing, component control and/or power supply or management. In one embodiment, the control/distribution box 28 is configured as a subsea distribution unit (SDU) capable of transmitting data and communications between remote PODs or back to surface units and selected subsea wellheads. As described herein, a “remote unit” refers to a component or assembly in operable communication with the subsea box, and may include a subsea unit or a facility located at the sea surface.

In one embodiment, the control/distribution box 28 includes a marinized switch 20 such as a fiber optic switch and/or modem to communicate with selected wellbores 12. The switch 20 may be a switch or a junction such as a power or hydraulic junction. Such communication may include data and/or power transmission for interrogation of the wellbore, formation and/or components therein. In one embodiment, the switch 20 is a multiplexer. The switch 20 transmits communication signals and/or power between remote units (such as subsea or surface units) and selected wellbores 12. In one embodiment, the switch 20 is connected in communication with at least one remote unit 22 via a suitable connector 24 such as a ROV wet-mate connector and flying lead 24. The remote unit 22 may be, for example, an additional subsea distribution unit (SDU), subsea control module (SCM) or surface unit. The fiber optic switch 20 may be connected to the remote unit 22 via any suitable mechanism, such as an optical fiber, electrical or hydraulic connection. In addition, although the switch 20 is described herein as a fiber optic switch, any suitable switching device or assembly may be used. The switch 20 may include any suitable type of switching unit such as one or more transistors or other electrical switches.

The control/distribution box 28 includes one or more connection ports 26, such as bulkhead connectors. The connection ports 26 are configured to be compatible with corresponding ROV connectors 27 going to selected wellheads. The connection ports 26, in one embodiment, are configured to be attached to the wellhead connection ports 27 via a ROV. In one embodiment, the connection ports 26 and/or the wellhead connection ports 28 include flying leads. In one embodiment, the control/communication box 28 includes a distribution spider which is terminated by connection ports 26.

In one embodiment, at least one of the connection ports 26 are blank, i.e., are not wired or connected to the control/distribution box 28 and do not include a connector. Thus, the subsea box 14 is not pre-wired. The subsea box 14 is upgradeable to configure the subsea box 14 for additional connection ports at a later time as desired. The subsea control/communication box can be upgraded, for example, by retrieving the subsea box 14, installing a connection port 26 (such as a fiber optic wet connect) and connecting or wiring the switch 20 to the connection port 26. The connection port 26 is configured to connect to a selected additional wellbore 12, for example, by reconfigured the connection port with a proper wet mateable bulkhead connector 26 that can be connected to one or more additional selected wellheads when the subsea box 14 is returned to the sea floor.

The switch 20 includes one or more data or power connection points configured to allow an optical, electrical or other connection between the remote unit 22 and selected subsea box connection ports 26. In one embodiment, at least one of the switch connection points are blank, i.e., are not present, are not wired to or otherwise operably connected to any of the subsea box connection ports 26.

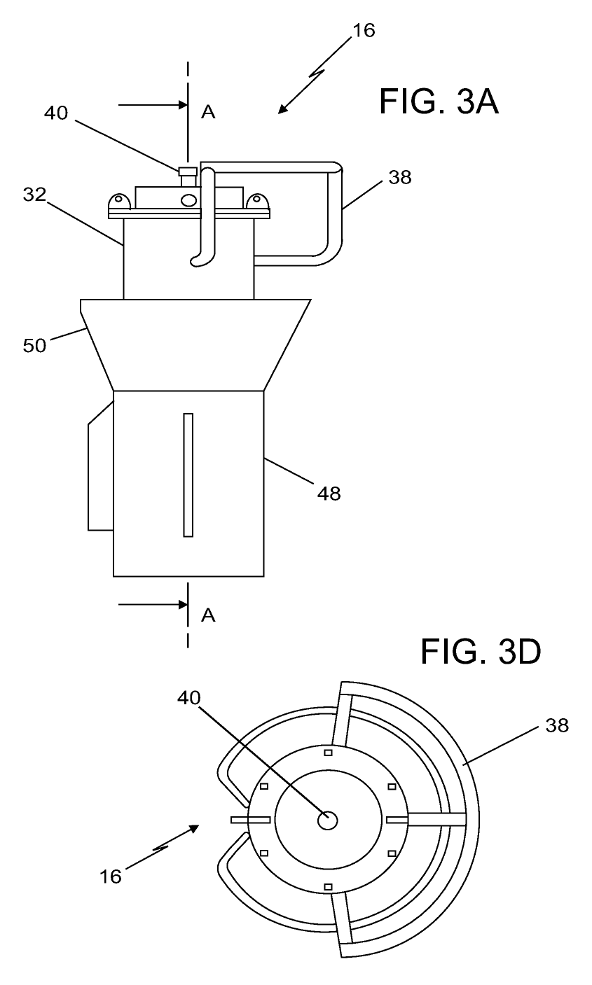

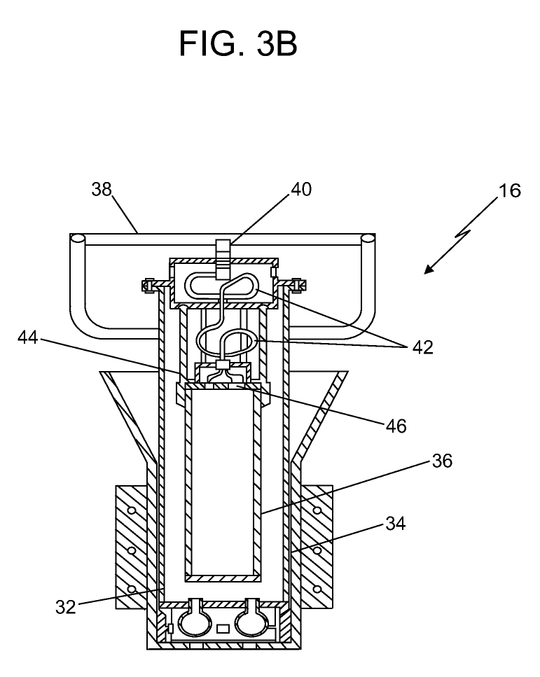

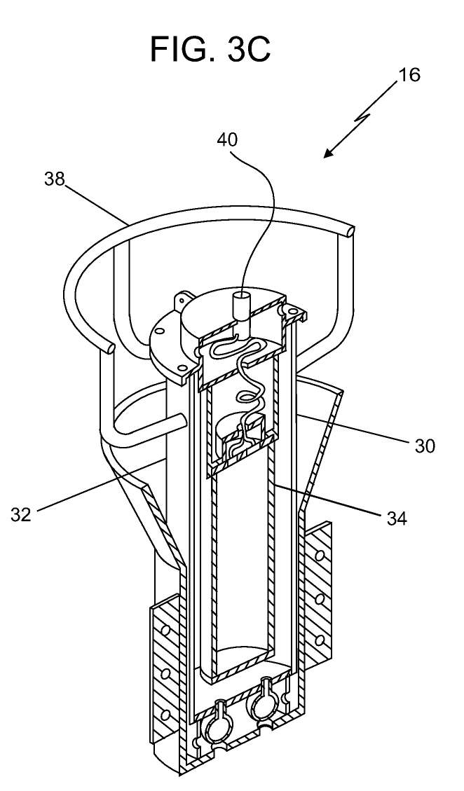

Referring to FIGS. 3A-3D, the interrogators (including suitable sensor or sensor assemblies) located in the monitoring unit 16 are connected to the subsea control/distribution box 28 by a communication connection terminated by, for example, an ROV connector. The monitoring unit 16 may be lowered and retrieved via, for example, an ROV. In one embodiment, the monitoring unit 16 is connected to the subsea box 14 by a flying lead 30, which may be controlled by a ROV. The monitoring unit 16, in one embodiment, includes a self-contained canister or other housing 32 that houses selected interrogators and/or tools for monitoring the wellbore 12, formation and/or components within the wellbore 12. The canister 32 includes any of various sensor assemblies for monitoring properties of the wellbore 12, the surrounding formation and/or components such as sensors within the wellbore 12 and within a production string. Examples of such sensor assemblies or tools include fiber optic tools such as real-time casing imagers (RTCI), real-time completion monitors (RTCM), distributed temperature sensors (DTS) and fiber optic pressure/temperature sensors, and various electrical sensors.

The canister 32 may take any form suitable to house the selected interrogators/tools and facilitate monitoring of the wellbore 12. For example, the canister 32 may be a single-walled or dual-walled enclosure. In one example, the canister 32 includes an outer chamber 34 and a removable inner chamber 36 configured to be disposed within the outer chamber 34. In one embodiment, the inner chamber 36 is an atmospherized container having an internal pressure of 1 atmosphere (ATM). The canister 32 is not limited to the exemplary descriptions included herein.

An exemplary configuration of the monitoring unit 16 is shown in FIGS. 3A-3D. In this example, the monitoring unit 16 includes a ROV grab bar 38 attached to the outer chamber 34 to allow a ROV to grasp and transport the monitoring unit 16, and an ROV connector 40 such as a hybrid plug that allows a ROV to lower the monitoring unit 16 into and retrieve the unit 16 from a wellbore 12. The ROV connector 40 is connected to the inner chamber 36 via, for example, an oil-filled hose 42. The hose 42 is further connected to a fiber optic penetrator 44 and an electrical penetrator 46. The monitoring unit 16 and/or the canister 32 are not limited to the embodiments described herein.

In one embodiment, the outer chamber 34 and/or the inner chamber 36 are pressure compensated to equalize selected internal pressures to water depth pressure by use of a pressure compensation system such as bladders, Pressure Balanced Oil Filled (PBOF) hoses (such as hose 42), diaphragms, or other compensation techniques.

In one embodiment, the monitoring unit 16 includes a receptacle basket or housing 48 configured to receive the canister 32 to facilitate deployment, and retrieval to the surface as needed. In one embodiment, the receptacle housing 48 includes a conical receptacle portion 50 configured to facilitate guidance and receiving the canister 32 in the receptacle housing 48.

The outer chamber 34, inner chamber 36 and receptacle housing 48 are made from a metallic material and/or any material suitable to protect at least the sensors and electronics within the inner chamber 36 from the subsea environment. In one embodiment, the inner chamber 36 and/or the outer chamber 34 have a generally cylindrical shape.

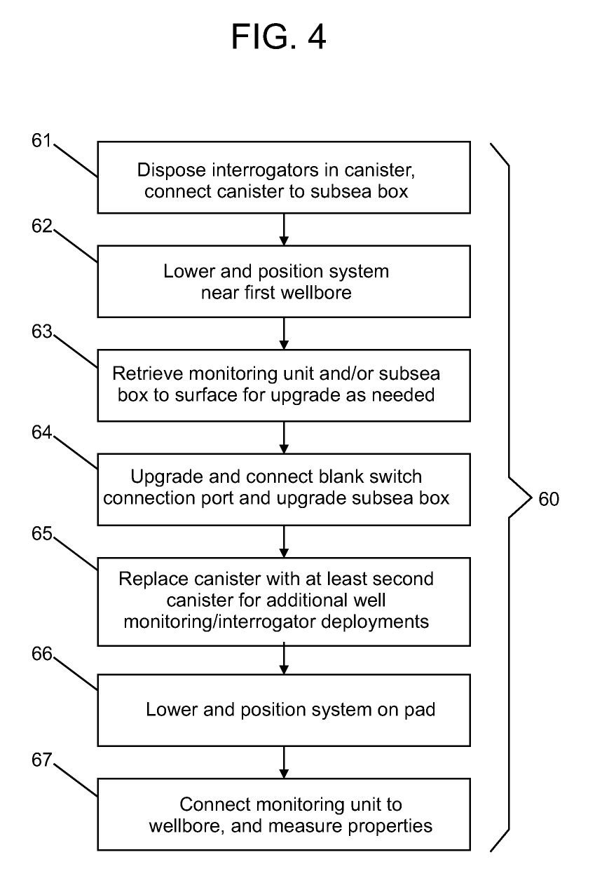

FIG. 4 illustrates a method 60 for monitoring components in a wellbore and/or modifying or upgrading the monitoring system 10. The method 60 includes one or more of stages 61-67 described herein. The method is described herein in conjunction with the system 10, although the method may be performed in conjunction with any number and configuration of processors, sensors and tools. The method may be performed by one or more processors or other devices capable of receiving and processing measurement data, such as a microprocessor and/or a computer. In one embodiment, the method includes the execution of all of stages 61-67 in the order described. However, certain stages 61-67 may be omitted, stages may be added, or the order of the stages changed.

In the first stage 61, the canister 32 (such as a canister or enclosure that may be pressurized, for example, to 1 ATM or any selected pressure) containing selected interrogators is connected to the control/distribution box 14 via, for example, a Remotely Operated Vehicle (ROV).

In the second stage 62, the system 10 is lowered from a surface facility via, for example, a ROV, and positioned at the sea floor and positioned to allow the system to be connected to a selected wellbore 12. A first bulkhead connector 26 is operably connected to a corresponding ROV connector of a first wellbore 12 to connect the system 10 to the first wellbore and allow communication between the system 10 and the first wellbore 12. The monitoring unit 16 is then activated to measure various properties within the wellbore 12 and/or of various components within the wellbore 12.

In the third stage 63, if one or more additional wellbores 12 are desired to be monitored, the monitoring unit 16 and/or system 10 is retrieved (via, for example, a ROV) and transported to the surface facility for upgrade.

In the fourth stage 64, the control/distribution box 14 is upgraded by installing a connector at a blank connection port 26 and connecting or wiring the switch 20 (such as at a blank connection point) to the blank connection port 26. In one embodiment, at least one blank switch connection point is populated to at least one blank connection port 26. In one embodiment, the box 14 is upgraded by reconfiguring a connection port 26 with a connector that can be connected to one or more additional selected wellheads. In another embodiment, the complete control box 14 and/or control/distribution box 28 is swapped with a unit containing additional distribution ports.

In the fifth stage 65, the canister 32 containing various interrogators is/can be swapped to contain additional interrogator units and/or for maintenance purposes of the deployed interrogators.

In the sixth stage 66, the system 10 is lowered from the surface facility and positioned at or near the sea floor and proximate to the second wellbore 12, such as on wellbore pad. The previously blank connection port 26 is operably connected to a corresponding wellhead connection port 27 of the second or additional wellbores 12 to attach the system 10 to the second or additional wellbores and allow communication between the system 10 and the second or additional wellbores 12.

In the seventh stage 67, the monitoring unit 16 is activated to measure various properties within the second or additional wellbores 12 and/or of various components within the wellbores 12.

Stages 64-67 may be performed for any number of wellbores 12. In this way, the system 10 is upgradeable as needed to configure the system to interrogate or monitor any number of wellbores without the need to pre-wire or pre-configure the system 10.

In one embodiment, the taking of measurements from the sensor assemblies disposed in the canister 32 and/or the inner chamber 36 are stored in onboard storage devices. The data retrieved during these processes may be transmitted to the surface, by way of the distribution control POD 28 and the switch 20.

In one embodiment, the control box 14 and/or the monitoring unit 16 include components as necessary to provide for storing and/or processing data collected from sensor assemblies within the canister 32. Exemplary components include, without limitation, at least one processor, storage, memory, input devices, output devices and the like.

As described herein, “subsea” wells or wellbores are wells that generally lack fixed access from the sea surface. Such wells include wellheads located at or proximate to the sea floor. Subsea wells are accessed via suitable cable connections such as umbilical jumpers.

As described herein, “borehole” or “wellbore” refers to a single hole that makes up all or part of a drilled well. As described herein, “formations” refer to the various features and materials that may be encountered in a subsurface environment. Accordingly, it should be considered that while the term “formation” generally refers to geologic formations of interest, that the term “formations,” as used herein, may, in some instances, include any geologic points or volumes of interest (such as a survey area). A “subsea” device refers to a device located generally at or above the sea floor but below the sea surface.

The systems and methods described herein provide various advantages over prior art techniques. The systems and methods described herein allow for monitoring multiple wells without requiring pre-wiring or pre-configuration for the multiple wells. Configuring each connection for multiple wellbores requires significant labor and expense. Thus, the ability to upgrade as needed the system can reduce expense by eliminating unnecessary connections.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for subsea wellbore monitoring, the system comprising:
a communication control unit configured to be disposed at a sea floor and connected to a monitoring unit that is disposable in communication with the wellbore;
a plurality of control unit connection ports disposed on the control unit and configured to operably connect with the subsea wellbore, the plurality of control unit connection ports including at least one blank control unit connection port; and
a switch disposed in the control unit including a plurality of switch connection points, the plurality of switch connection points including at least one blank switch connection point configured to be operably connected to the at least one blank control unit connection port.

2. The system of claim 1, wherein the switch is selected from at least one of a fiber optic switch, an electrical switch and a multiplexer.

3. The system of claim 1, wherein the monitoring unit is disposable proximate to a subsea tree associated with the wellbore, and the plurality of control unit connection ports are configured to operably connect with the subsea tree.

4. The system of claim 1, further comprising a subsea platform configured to support the control unit and the monitoring unit.

5. The system of claim 1, further comprising at least one communications connection between the control unit and a surface facility.

6. The system of claim 1, wherein the monitoring unit is connected to the control unit via a flying lead.

7. The system of claim 1, wherein the control unit connection ports are compatible with at least one wellhead connection port disposed at a wellhead of the subsea wellbore.

8. The system of claim 1, wherein the monitoring unit includes a self-contained chamber having at least one sensor assembly disposed therein.

9. The system of claim 8, wherein the at least one sensor assembly is selected from at least one of a pressure sensor, a temperature sensor, a real time casing imager (RTCI) a distributed temperature sensor (DTS) assembly, and a pressure/temperature sensors.

10. The system of claim 8, wherein the self-contained chamber is a 1 ATM canister.

11. A method of modifying a subsea wellbore monitoring system, the method comprising:
retrieiving the wellbore monitoring system from a subsea location, the system including a control unit connected to a monitoring unit disposable in communication with a first wellbore, the control unit including a switch disposed therein for control of monitoring components in the monitoring unit and a plurality of control unit connection ports having at least one blank control unit connection port, the switch including a plurality of switch connection points including at least one blank switch connection point; and
upgrading the control unit to populate the at least one blank switch connection point to the at least one blank control unit connection port, and configuring the at least one blank control unit connection port to be operably connected to a an additional wellbore selected for monitoring.

12. The method of claim 11, further comprising disposing the wellbore monitoring system at a location proximate to the second wellbore, operably connecting the at least one blank control unit connection port to the second wellbore.

13. The method of claim 12, further comprising connecting the monitoring unit to a wellhead of the second wellbore to establish communication between the second wellbore and the monitoring unit.

14. The method of claim 12, further comprising measuring at least one property of the second wellbore via the monitoring unit.

15. The method of claim 14, wherein the at least one property includes at least one property of at least one sensor assembly disposed within the second wellbore.

16. The method of claim 11, wherein the wellbore monitoring system and the monitoring unit are transportable via at least one remote operated vehicle (ROV).

17. The method of claim 11, wherein lowering the system includes positioning the system on a sea floor.

18. The method of claim 11, wherein the monitoring unit includes a removable self-contained chamber that houses at least one sensor interrogator assembly.

19. The method of claim 18, wherein the at least one sensor assembly is selected from at least one of a pressure sensor, a temperature sensor, a real time casing imager (RTCI) and a distributed temperature sensor (DTS) assembly.

20. The method of claim 18, wherein upgrading includes replacing the removable self-contained chamber with a second removable self-contained chamber housing at least one second sensor assembly configured to measure selected properties of the second wellbore.
